(19) United States
(12) Patent Application Publication
(10) Pub. No.: US 2005/0021909 A1
(43) Pub. Date: Jan. 27, 2005

(54) Memory cartridge including selecting mechanism

(75) Inventors: Michael Much, San Jose, CA (US); Michael Perkins, Santa Clara, CA (US); Richard Glen Freeman, San Carlos, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: LeapFrog Enterprises, Inc., Emeryville, CA (US)

(21) Appl. No.: 10/627,083

(22) Filed: Jul. 24, 2003

(51) Int. Cl. G06F 13/00

(52) U.S. Cl. 711/115

(57) ABSTRACT

A memory cartridge is disclosed. In one embodiment, the memory cartridge has a housing, and a memory unit in the housing, where the memory unit stores a plurality of data sets. An edge connector is electrically coupled to the memory unit. A selector is coupled to the housing and the selector is adapted to select at least one of the data sets. A locking member for locking the selector is coupled to housing.

### BACKGROUND OF THE INVENTION

Memory cartridges are used in a number of entertainment, gaming, and educational apparatuses. A memory cartridge provides new content for an entertainment and/or educational apparatus.

A typical memory cartridge contains a single data set associated with a single end-user application. For example, a conventional video game cartridge may have data for a single game on it. A user can only play that game on the video gaming apparatus. If the user wants to play a different game, the user must switch out the game cartridge with a different game cartridge.

While conventional memory cartridges are useful, a number of improvements could be made. First, owning multiple memory cartridges is burdensome. For example, if a user owns many individual books and memory cartridges containing audio for those books (for a book reading apparatus), some memory cartridges may tend to get lost. The user may have books, without corresponding memory cartridges. It is difficult to keep track of a dozen or more game cartridges for a dozen different books.

While it possible to store many different data sets for many games or many books on a single memory cartridge, the memory cartridge may not be compatible with the hardware and/or software on a conventional entertainment, gaming, and/or educational device that is designed for use with a memory cartridge having a single data set. The conventional entertainment, gaming or educational device would not be able to distinguish between the different data sets stored inside of the memory cartridge unless the right hardware or software is provided on the device. For example, a gaming device may be designed for use with a single cartridge containing data for a single game. A game cartridge with multiple games on it may not work with the gaming device, since it is not designed for use with many different games on a single cartridge. In this case, significant changes to the gaming device would have to be made in order for the user to be able to use the different games on the single gaming cartridge.

Embodiments of the invention address the above problems and other problems, individually and collectively.

### SUMMARY OF THE INVENTION

Embodiments of the invention are directed to a memory cartridge that contains two or more data sets, as well as kits and devices that include the memory cartridges.

One embodiment of the invention is directed to a memory cartridge comprising: (a) a housing; (b) a memory unit in the housing, wherein the memory unit stores a plurality of data sets; (c) an edge connector electrically coupled to the memory unit; (d) a selector coupled to the housing, wherein the selector is adapted to select at least one of the data sets; and (e) a locking member for locking the selector.

Another embodiment of the invention is directed to a kit comprising: (a) a memory cartridge comprising (i) a housing, (ii) a memory unit in the housing, wherein the memory unit stores a plurality of data sets for different print media, (iii) an edge connector electrically coupled to the memory unit, (iv) a selector coupled to the housing, wherein the selector is adapted to select at least one of the data sets, and (v) a locking member for locking the selector, the locking member being coupled to housing; and (b) the different print media.

Another embodiment of the invention is directed to a memory cartridge comprising: (a) a housing having a first side and a second side; (b) a memory unit in the housing, wherein the memory unit stores a plurality of data sets for different print media; (c) a selector coupled to the housing, wherein the selector is adapted to select at least one of the data sets; and (d) an edge connector electrically coupled to the memory unit.

Another embodiment of the invention is directed to a kit comprising: (a) a memory cartridge comprising (i) a housing having a first side and a second side, (ii) a memory unit in the housing, wherein the memory unit stores a plurality of data sets for different print media, (iii) a selector coupled to the housing, wherein the selector is adapted to select at least one of the data sets, and (iv) an edge connector electrically coupled to the memory unit; and (b) the different print media.

Another embodiment of the invention is directed to a memory cartridge comprising: (a) a housing having a first side and a second side; (b) a window at the first side of the housing; (c) a memory unit in the housing, wherein the memory unit stores a plurality of data sets for different print media; (d) an edge connector electrically coupled to the memory unit; (e) a dial at the second side of the housing, wherein the dial is adapted to select at least one of the data sets; (f) a wheel coupled to the dial, wherein the wheel has a structurally coded surface at a first side and a plurality of indicia at a second side, wherein at least one indicium of the plurality of indicia shows through the window; (g) an illumination source between the wheel and the dial; and (h) a locking member for locking the selector, the locking member being coupled to housing.

Other embodiments of the invention are directed to apparatuses incorporating the memory cartridges.

These and other embodiments of the invention are described in further detail below.

### BRIEF DESCRIPTION OF THE DRAWINGS

FIG. 1 shows a perspective view of a memory cartridge according to an embodiment of the invention from a top side.

FIG. 2 shows a perspective view of a memory cartridge according to an embodiment of the invention from a bottom side.

FIG. 3 shows a side view of a memory cartridge according to an embodiment of the invention.

FIG. 4 shows an exploded view of a memory cartridge from a top view perspective.

FIG. 5 shows an exploded view of a memory cartridge from a bottom view perspective.

FIG. 6 shows a bottom portion of a memory cartridge according to an embodiment of the invention.

FIG. 7 shows an exploded view of a finger assembly inside of a memory cartridge.

FIG. 8 shows a bottom portion of a memory cartridge when the locking member is in an unlocked position.

FIG. 9 shows a bottom portion of a memory cartridge when the locking member is in a locked position.

FIG. 10 shows a schematic diagram of a memory cartridge when it is used with an electrographic position location device and a book. The Figure shows the relative positions of a wheel and a dial in the memory cartridge when it is used with an external device.

### DETAILED DESCRIPTION

One embodiment of the invention is directed to a memory cartridge comprising a housing, and a memory unit in the housing, wherein the memory unit stores a plurality of data sets. An edge connector is electrically coupled to the memory unit. A selector is coupled to the housing, and the selector is adapted to select at least one of the data sets. The selected data set is used with an external device. The memory cartridge includes a locking member that is coupled to the housing. When the locking member is actuated, the selector is locked out so that the selector cannot be used to make a further selection. The locking member is preferably automatically actuated when the user joins the memory cartridge to the device that uses the memory cartridge. By doing so, the user cannot manipulate the selector when the memory cartridge is used with an external device.

The housing of the memory cartridge may comprise a plastic housing. The plastic housing may be formed from two or more housing portions that are secured together. Securing devices such as glue, screws, bolts, etc. may be used to secure the housing portions together. The plastic housing protects the memory unit storing the data sets and other components inside of the memory cartridge. The housing can include a recess at its side. The recess can contain an edge connector that allows the memory cartridge to be mechanically and electrically connected to an external device such as a gaming device.

The edge connector may have any suitable form. For example, the edge connector may be a male-type edge connector such as a multi-contact edge connector formed from a PCB (printed circuit board) with a plurality of printed conductive lines on it. Alternatively, the edge connector may include multiple pins that extend away from the memory cartridge (e.g., like an RS-232 type connector). In yet other embodiments, the edge connector could be a female-type connector that has holes for receiving multiple pins or a slot for receiving a printed circuit board with printed conductive lines on it. The edge connector allows the memory cartridge to be connected to an external device such as a book reading device or a gaming device.

A plurality of data sets is stored in the memory unit in the memory cartridge. The plurality of data sets may include two or more data sets associated with two or more end user applications. For example, the plurality of data sets may comprise a first audio data set associated with a first book, a second audio data set associated with a second book, and a third audio data set associated with a third book, etc. In another example, the plurality of data sets may comprise a first game data set associated with a first game, a second game data set associated with a second game, and a third game data set associated with a third game. In yet another example, the plurality of data sets may comprise a first data set associated with letters, a second data set associated with numbers, and a third data set associated words, etc. In yet another example, the plurality of data sets may comprise a first data set associated with a first lesson plan, a second data set associated with a second lesson plan, a third data set associated with a third lesson plan, etc. In still another example, the first data set has audio data for a first sheet or set of sheets, a second data set has audio for a second sheet or set of sheets, etc. Preferably, the data sets comprises audio data (e.g., word data).

In some embodiments, each data set in the plurality of data sets may occupy a pre-defined storage capacity in the memory unit. For example, if a ROM chip in the memory unit has 32 MB of storage capacity, 2 MB of storage may be allocated for each data set for each book. The memory cartridge containing the memory unit may then store 16 different audio data sets for 16 different books.

The memory unit in the housing may comprise one or more memory chips mounted on a circuit board or other circuit substrate. The memory chips may include a read only memory (ROM), a static random access memory (SRAM), or a reprogrammable memory such as an electronically erasable programmable read only memory (EEPROM) (e.g., a flash memory). Preferably, the memory unit comprises at least one non-volatile memory device. The memory storage capacity of the memory unit may vary, and may be 16 MB or 32 MB, or more. Memory storage capacity will increase as data storage technology improves.

A selector is coupled to the housing and allows a user to select at least one data set from the plurality of data sets stored in the memory unit. The selector may be a physical device that the user may physically manipulate to choose a particular data set. The selector is preferably in the form of a circular dial (e.g., in the form of a wheel). However, in other embodiments, the selector may be in the form of a mechanical switch such as a slide switch, a lever, or other configuration.

The memory cartridge can be used in any suitable interactive apparatus. Examples of suitable apparatuses include gaming apparatuses, as well as electrographic position location apparatuses. The electrographic position location apparatuses may include a globe or a platform, and may have a recess that includes the memory cartridge. If it has a platform, the platform may support a book that the user may read and/or interact with. Examples of electrographic position location apparatuses are described in U.S. patent application Ser. No. 09/574,599 filed May 19, 2000, Ser. No. 60/200,960, filed May 1, 2000, and Ser. No. 60/200,722 filed Apr. 27, 2000. Other suitable apparatuses are described in U.S. Pat. Nos. 5,575,659, 5,686,705, and 5,877,458. Other suitable apparatuses are also described in U.S. patent applications Ser. No. 09/886,401, filed Jun. 20, 2001, Ser. No. 09/886,399, filed Jun. 20, 2001, and Ser. No. 10/222,205, filed Aug. 16, 2002. Each of these U.S. Patents and U.S. Patent Applications is herein incorporated by reference in its entirety for all purposes, and is assigned to the same assignee as the present application.

In some embodiments, the electrographic position location apparatus may include a platform or globe. In embodiments of the invention, the platform (or globe) may include a transmitting antenna and a receiving antenna may be in a stylus that is operatively or physically coupled to the platform (or globe). The transmitting antenna may be inside of the platform (or globe) and may contain a number of conductive elements (e.g., conductive fingers) that radiate different electromagnetic signals. When the stylus is positioned over a particular point on the platform (or globe), it receives a particular signal corresponding to a particular x-y (and/or z-position) position. A microprocessor inside of the electrographic position location apparatus can determine which x-y position was selected by the user. If the x-y position corresponds to a specific print element such as a word or an image of a country, the electrographic position location apparatus can produce an output that is specific to the selected image. For example, the electrographic position location apparatus may include a speaker (and an amplifier) or a display. An audio or visual output may be produced in response to a user's specific selection using the stylus. Examples of such electrographic position location apparatuses are provided in the patents and patent applications described above.

The memory cartridge according to embodiments of the invention may be hand-held and portable, and may have any suitable shape. For example, the size of the cartridge may be about 14″×12″×5″ in some embodiments.

Specific examples can be described with reference to the Figures. Many of the examples that are discussed below refer to the use of a plurality of book data sets containing audio data. However, as indicated above, other data sets such as data sets associated with games can be used in embodiments of the invention. Also, in describing the embodiments below, words such as “upward” and “downward” are used to describe the relative positions of some elements as they are shown in the Figures. These words are not intended to be limiting as the memory cartridges could be oriented in any suitable way so that a particular element may move upward or downward depending upon the absolute orientation of the memory cartridge.

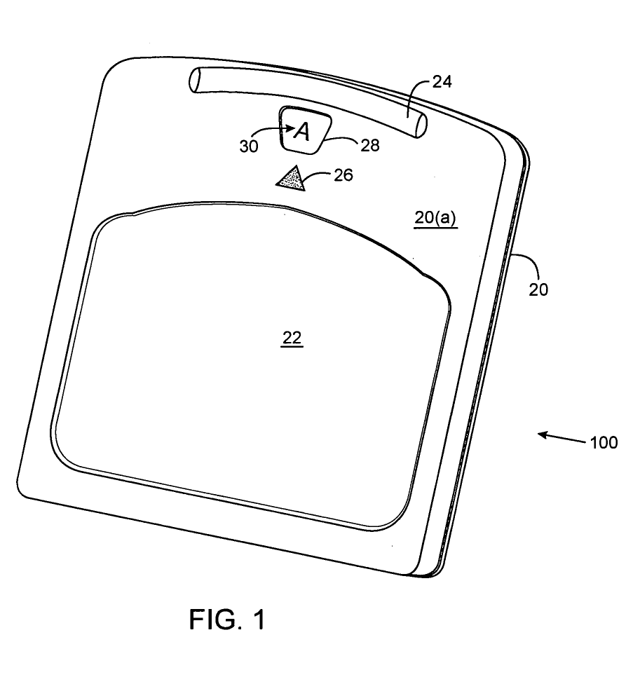

FIG. 1 shows a top perspective view of a memory cartridge 100. The memory cartridge 100 includes a housing 20 with an upper portion 20(a) and a lower portion. A window 28 is in the upper portion 20(a) of the housing 20. The window 28 shows an indicium 30 of a plurality of indicia that are on a second side of a wheel inside of the housing 20. The first side of the wheel can be structurally encoded for the different data sets stored in the memory unit (not shown) in the memory cartridge 100. A first indicator 26 is on the upper portion 20(a) of the housing 20. It points the user to the current book data set that would be usable by an external book reading device. For purposes of illustration, the letter “A” shown in the window 28 can represent the data set associated with a single book (not shown). A protrusion 24 extends upward from the upper portion 20(a) of the housing 20. The protrusion 24 helps a user grip the memory cartridge 100 when, for example, the memory cartridge 100 is being withdrawn from a recess in a housing of an external device.

A label 22 is on the upper portion 20(a) of the housing 20. The label 22 may be used to identify the various data sets stored inside of the memory cartridge 100. For example, if the memory cartridge 100 has ten different data sets for ten different books, the label 22 may list the titles of books 1-10 to indicate to the user that ten different data sets for ten different books are stored in the memory cartridge 100.

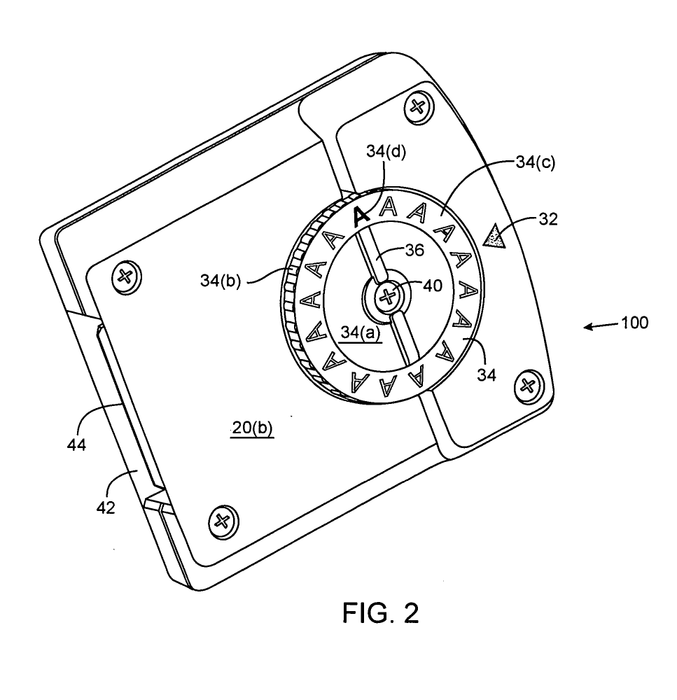

FIG. 2 shows a bottom perspective view of the memory cartridge 100 shown in FIG. 1. The second portion 20(b) of the housing 20 is secured to the first portion 20(a) of the housing 20 with a number of screws.

FIG. 2 shows a selector in the form of a dial 34 coupled to the second portion 20(b) of the housing 20. A screw 40 couples the dial 34 to the lower portion 20(b) of the housing 20, and the dial 34 rotates about the screw 40. The dial 34 may be at a first side of the memory cartridge 100, while the window 30 (see FIG. 1) may be at a second side of the memory cartridge 100. The dial 34 includes a circular outer portion 34(c) that surrounds a depression 34(a). The edge 34(b) of the dial 34 is knurled so that a user can easily grip the dial 34. A linear middle portion 36 is molded into the dial 34 so that the user can turn the dial 34 in different ways. A user can turn the dial by gripping the linear middle portion 36. Alternatively, the user can turn the dial 34 by gripping the outer knurled edge 34(b) of the dial 34.

Indicia 34(d) are located on the circular outer portion 34(c) of the dial 34. Each indicium of the indicia 34(d) can correspond to a different data set. For example, each indicium may correspond to a different audio set for a different book. In FIG. 2, the indicia 34(d) are illustrated as 16 “A” letters. In embodiments of the invention, the 16 “A” letters could alternatively be the numbers 1-16, or the letters A-P. A second indicator 32 points to a particular indicium on the dial 34 to indicate to the user which book is being selected.

The edge of the memory cartridge 100 includes a recess 42 and an edge connector 44 is in the recess 42. The edge connector 44 in this example is a male edge connector. In other embodiments, the edge connector 44 could be a female edge connector. The recess 42 houses the edge connector 44 and protects it from potential external damage. In other embodiments, the recess 42 need not be present and edge connector 44 could extend outwardly from the housing 20, without being protected by a recess.

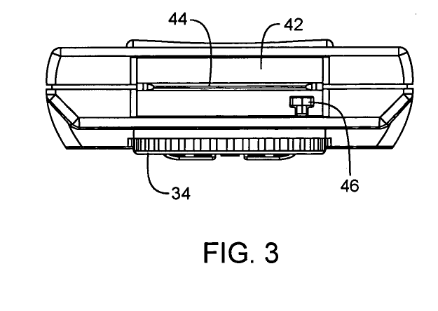

FIG. 3 shows a side view of a memory cartridge 100. FIG. 3 shows the edge connector 44 within the recess 42. A locking member 46 is within the recess 42 and extends outward from the housing 20(b) and is adjacent to the edge connector 44. When the memory cartridge 100 engages a housing (not shown in FIG. 3) of an external device, the housing depresses the locking member 46 inwardly. Thus, the locking member 46 is automatically actuated when the memory cartridge is attached to the housing of an external device that uses the memory cartridge. In this example, the locking member 46 is in the form of a locking arm. Although a locking arm is shown, other locking members could be used. For example, a locking member in the form of a lever could be used instead of an inward moving locking arm.

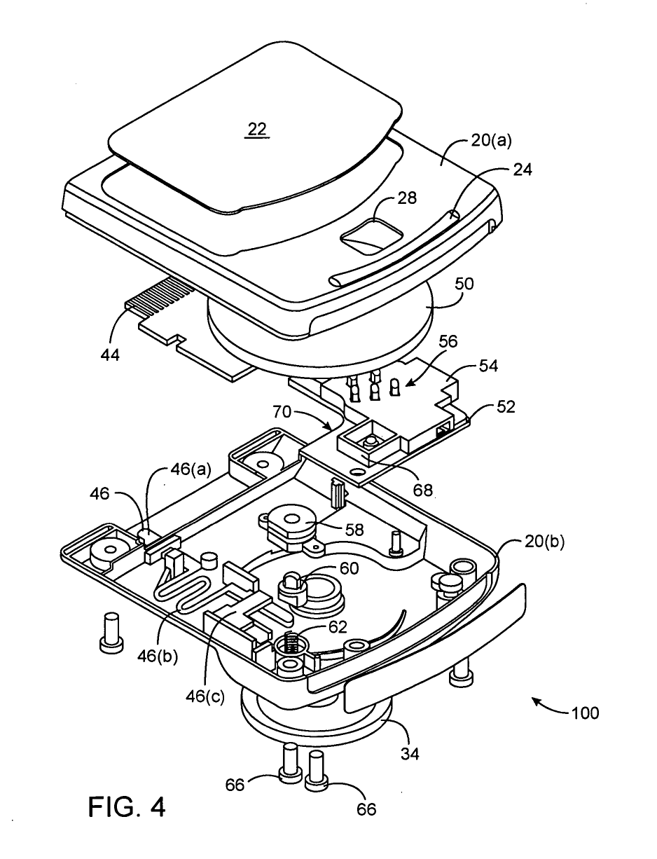

FIG. 4 shows an exploded view of a memory cartridge 100 according to an embodiment of the invention. The first and second housing portions 20(a), 20(b) are coupled together with a number of screws 66. The dial 34 is outside of the second housing portion 20(b) and engages a wheel 50 inside of the memory cartridge 100. The connector 44 is part of a printed circuit board, a portion of which is disposed internal to the memory cartridge 100.

The memory cartridge 100 includes a finger assembly. The finger assembly includes a circuit board 52 and a body 54, wherein the body 54 includes a light containment portion 68. The light containment portion 68 includes an illumination source 70, which directs light upward and illuminates a portion of the wheel 50. The wheel 50 may be translucent or transparent so that any light emitted from the illumination source 70 passes through the wheel 50 and illuminates an indicium on the wheel that shows through the window 28 in the first housing portion 20(a). Electricity for the illumination source 70 can be supplied through a power source in the memory cartridge 100 or in a device that is used in conjunction with the memory cartridge 100. The illumination source 70 helps a person see the indicium shown through the window 28.

The body 54 also houses a plurality of movable fingers 56. The movable fingers selectively engage crevices and protrusions on the underside of the wheel 50. The crevices and protrusions may form a structural pattern so that the wheel 50 is structurally encoded. The underside of the wheel 50 may be patterned differently at different angular positions. For example, 10 different angular positions may have 10 different structural patterns. The different structural patterns at the different angular positions may correspond to the different data sets stored in the memory unit and the different indicia on the wheel 50.

In this example, there are five movable fingers 56. The underside of the wheel 50 has a specific pattern of crevices and protrusions which will selectively cause various combinations of movable fingers 56 to depress or not depress. When a specific set of movable fingers 56 is depressed, a specific set of electrical switches inside of the body 54 is engaged. The specific set of electrical switches that is activated by a specific set of movable fingers 56 can indicate to a microprocessor in an external device (or in the memory cartridge 100) which data set in the memory cartridge 100 is to be used by the external device. Each finger 56 can be upwardly biased in the absence of downward pressure on the fingers 56.

The memory cartridge 100 includes a locking mechanism including the locking member 46. The locking member 46 in this embodiment includes a first outer portion 46(a), a second middle inner portion 46(b) that is curved, and a third inner portion 46(c) in the form of a two-prong fork. The curved second middle inner portion 46(b) allows the locking member 46 to flex as it moves inward and outward during use, thus reducing the likelihood of breakage.

When the locking member 46 is in an inward, locked position (as would be caused by an inward biasing force provided by engagement with an external device that is used with the memory cartridge 100), the third inner portion 46(c) can slide under a detent 60. The detent 60 cannot move downward and is temporarily fixed in an upward position. The temporarily fixed detent 60 engages crevices (not shown in FIG. 4) on the underside of the wheel 50 so that the wheel 50 is fixed and cannot move. The wheel 50 and the dial 34 are consequently “locked out” so that a user cannot change the current data set. The detent 60 fits within a detent housing 58 and is allowed to move within the housing.

When the locking member 46 is in an outward, unlocked position (e.g., due to the absence of an inwardly biasing force provided by a housing of a device that is used with the memory cartridge 100), the third portion 46(c) does not engage the detent 60 and keeps the detent 60 in an upward position. When the third portion 46(c) does not engage the detent 60, the detent 60 is upwardly biased with the spring 62 that is under the detent 60. However, the detent 60 can freely move downward if downward pressure is applied. As the detent 60 engages the crevices on the underside of the wheel 50 as the wheel is moved in a clockwise or counterclockwise direction, the detent 60 moves up and down. A clicking sound can be heard due to the mechanical interaction with the crevices to provide the user with a clicking sound that corresponds to a data set change. In this case, the wheel 50 and the dial 34 are not in a “locked” position so that the user can freely turn the dial 34.

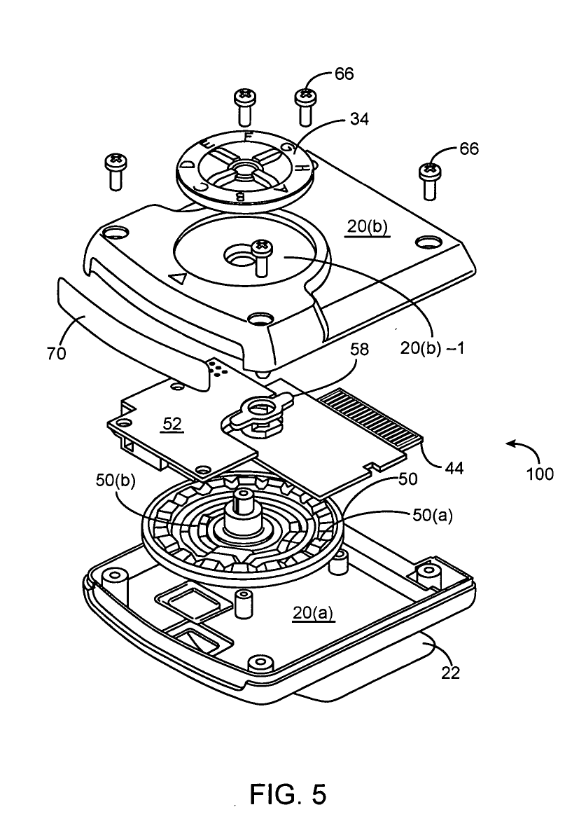

FIG. 5 shows another exploded view of the memory cartridge 100 according to an embodiment of the invention, from the opposite perspective as the perspective in FIG. 4. In FIG. 5, the underside of the wheel 50 is shown in greater detail. The outer circumference of the wheel includes a number of locking crevices 50(a) in which the detent 60 (see FIG. 4) can be inserted. The locking crevices 50(a) may be at the same general radius on the wheel 50 and may have the same shapes at different angular positions. An inner circumference of the wheel includes structural patterns 50(b) that are specifically encoded to depress certain sets of fingers 56 (see FIG. 4). Each angular position can have a different structural pattern so that a different set of fingers 56 is depressed when the wheel 50 is at a different position.

FIG. 5 also shows the outer surface of the dial 34. The outer circumferential area of the dial 34 has a plurality of indicia on it. Each separate indicium may represent a different data set that is stored in a memory unit in the memory cartridge 100.

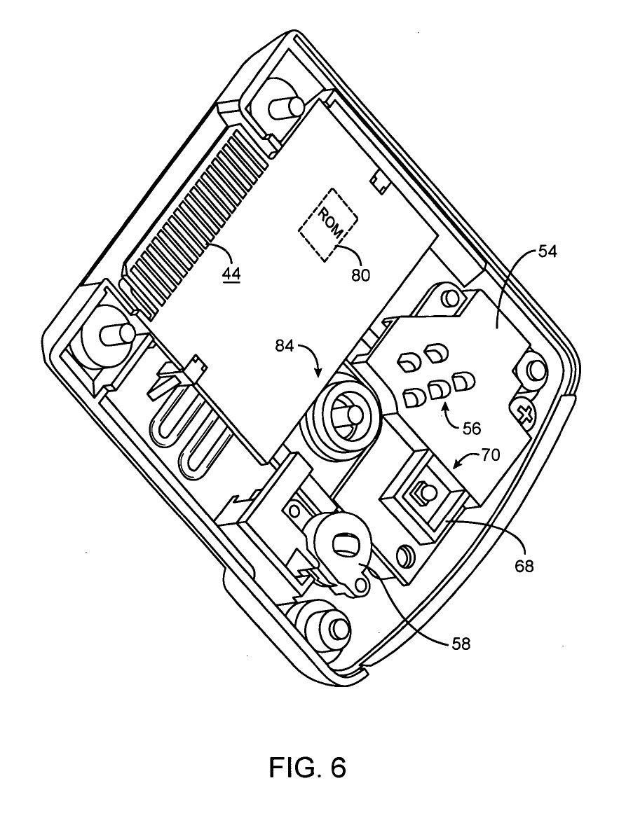

FIG. 6 shows a portion of the memory cartridge when its internal parts are assembled together. FIG. 6 additionally shows a memory unit in the form of a ROM chip 80 in dotted lines. The ROM chip 80 would be mounted under circuit board 44 and would be in electrical communication with the conductive tabs forming the connector 44. As is known by those of ordinary skill in the art, circuit lines may be provided on the circuit board 44 to provide input and output circuit paths (not shown in FIG. 6) to and from the ROM chip 80.

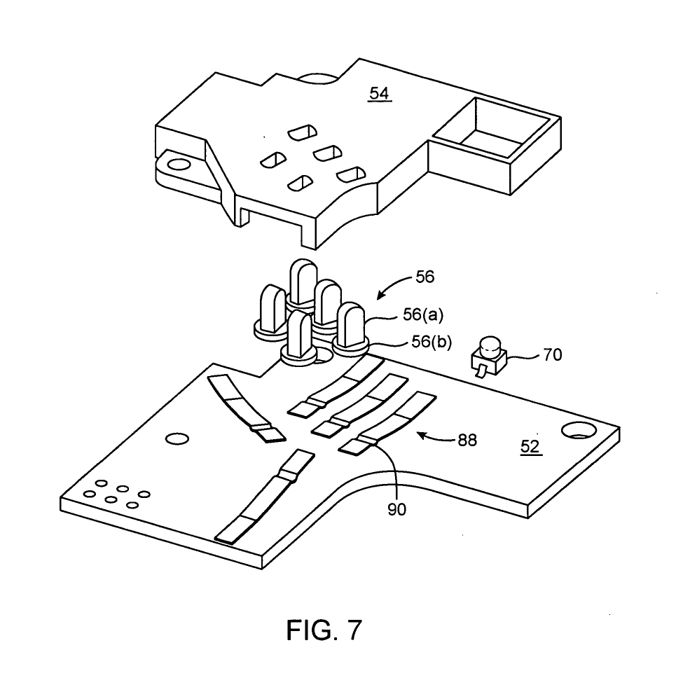

FIG. 7 shows an exploded view of a finger assembly inside of the memory cartridge. The finger assembly includes a plurality of fingers 56, each finger having a base 56(b) and a linear portion 56(a). The body 54 is disposed above a circuit board 52. For clarity of illustration, the circuit lines on the circuit board are omitted. An illumination source 70 is mounted on the circuit board 52.

The linear portions 56(a) of the fingers 56 can pass through apertures in the body 54. Each finger 56 interacts with a cantilevered conductor 88. Each cantilevered conductor 88 has an upwardly biased portion and can be pressed downward and can contact an conductive pad (now shown) when a corresponding finger 56 is pressed downward. A curved part 90 of the cantilevered conductor 88 can make contact with the conductive pad. A specific set of cantilevered conductors 88 can form electrical connections and may thus act as switches. The specific set of electrical connections can signal to a microprocessor (not shown) in the memory cartridge or in an external apparatus which data set is currently in use.

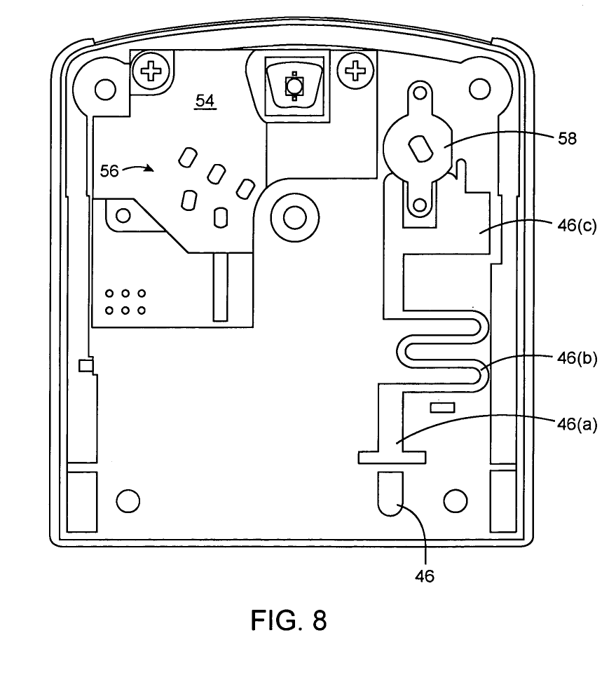

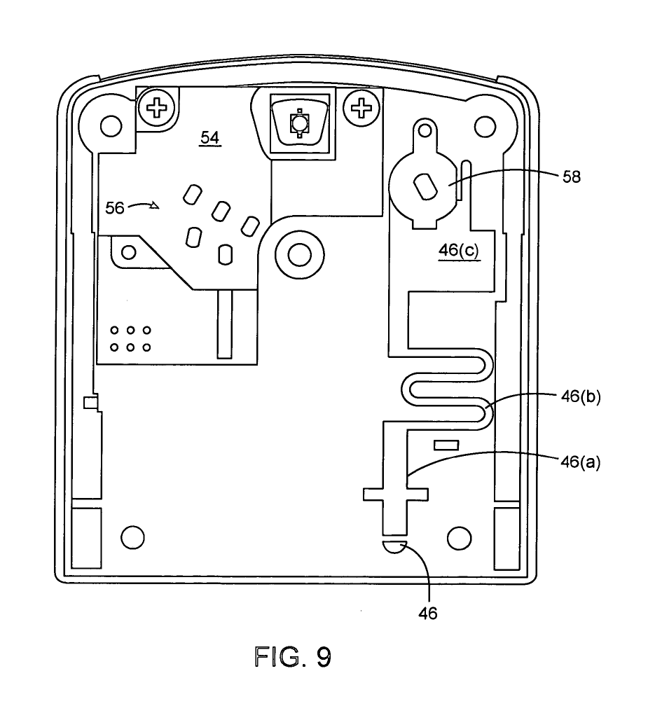

FIG. 8 shows a plan view of the locking member 46 when it is in an unlocked position. FIG. 9 shows a plan view of the locking member 46 when it is in a locked position. As shown in FIG. 8, the third inner portion 46(c) of the locking member 46 does not engage the detent 60 so that the detent 60 is biased upward, but is free to move downward. As shown in FIG. 9, the third inner portion 46(c) of the locking member 46 engages the detent 58 so that the detent 60 cannot move downward and is fixed in an upward position.

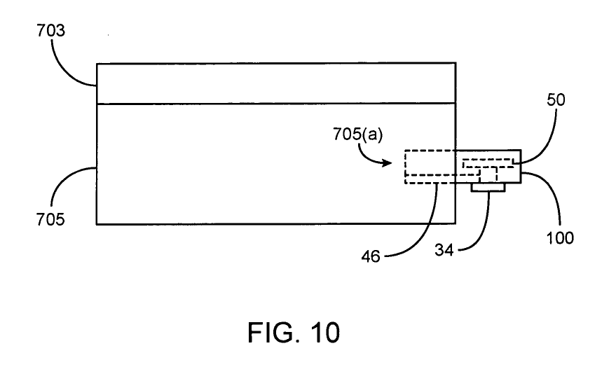

FIG. 10 shows how the memory cartridge 100 could be used with an electrographic position location device 705 in the form of a platform. A book 703 may rest on the upper surface of the device 705. Alternatively, the book 703 may be a sheet of paper, a template, etc. A memory cartridge is inserted into a recess 705(a) in the housing of the device 705.

The dial 34, which turns the wheel 50 (which displays an indicium for a particular book) is on the underside of the memory cartridge 100 when the memory cartridge 100 is in use. Because the dial 34 it is not visible to the user when the user is reading the book 703, the user does not have the impulse to want to turn the dial 34 when the memory cartridge 100 is actually in use. Also, the locking member 46 is pushed inward by the surface forming the recess 705(a) so that the dial 34 is “locked out” and cannot turn. These mechanisms help to ensure that a user will not turn the dial 34 when the memory cartridge 100 is in use.

In some embodiments, the memory cartridge may be used with different print media such as different books or different sheets. The memory cartridge and print media for the data cartridges may be present in a kit. For example, a kit according to an embodiment of the invention may comprise (i) a memory cartridge storing a plurality of audio data sets for a plurality of books, and (ii) the plurality of books. In another example, a kit may include (i) a memory cartridge storing a plurality of audio data sets for a plurality of sheets, and (ii) the plurality of sheets. The books may be children's books, and the sheets may be coloring sheets. Both the sheets and the books may teach children about one or more predetermined subjects including math, science, reading, letters, phonics, etc.

Embodiments of the invention have a number of advantages. First, embodiments of the invention are convenient for the user to use. For example, a single cartridge may be used with many different books, and a user need not obtain a different memory cartridge for each book that is used. Second, since an electro-mechanical mechanism for switching between the various data sets in the memory cartridge, the memory cartridge can be used with existing devices and apparatuses that may not have originally been designed for use with a memory containing multiple data sets. Third, as noted above, the selector in the memory cartridge can “lock out” after the user couples the memory cartridge to a corresponding device. This prevents a user such as a child from turning the selector mechanism when the memory cartridge is in use. Fourth, in preferred embodiments, the selector mechanism faces downward and is not displayed to the user when the memory cartridge is in use. The user does not have the urge to move the selector when the memory cartridge is in use, since the user does not see the selector.

In embodiments of the invention, to use the selector to select a different data set, the user is forced to take the memory cartridge out of any device currently being used, turn it over, and change the current data set using the selector. These features deter users from trying to “play with” or use the selector during use. Young children, for example, may have a tendency to want to play with the selector in the memory cartridge. If a child plays with or tries to change the data set that is currently being used by a device connected to the memory cartridge, the electronics in the device may not work properly. Accordingly, it is desirable to “lock out” the selector when it is in use to prevent a user from doing this.

The lock out feature of embodiments of the invention is particular useful with when the data sets comprise book data, as opposed to pure music data. For example, if a lock out feature is not provided in a memory cartridge storing music data sets, a user is free to interrupt any song that is currently being played by an external device. Interrupting a song is less frustrating than interrupting the audio being played for a particular book. When using a book reading apparatus, the audio for the particular book is for only that book. If the user changes the data set by moving the selector when audio for that book is being played by a book reading device, the current book that is being used is no longer relevant to the audio that is being played. This would be frustrating to a user. Accordingly, embodiments of the invention advantageously lock out the selector to prevent the user from using the selector when the memory cartridge is being used with an external device.

The terms and expressions which have been employed herein are used as terms of description and not of limitation, and there is no intention in the use of such terms and expressions of excluding equivalents of the features shown and described, or portions thereof, it being recognized that various modifications are possible within the scope of the invention claimed. Moreover, any one or more features of any embodiment of the invention may be combined with any one or more other features of any other embodiment of the invention, without departing from the scope of the invention.

All references, patent applications, and patents mentioned above are herein incorporated by reference in their entirety for all purposes. None of them are admitted to be prior art to the presently claimed inventions.

1. A memory cartridge comprising:
(a) a housing;
(b) a memory unit in the housing, wherein the memory unit stores a plurality of data sets;
(c) an edge connector electrically coupled to the memory unit;
(d) a selector coupled to the housing, wherein the selector is adapted to select at least one of the data sets; and
(e) a locking member for locking the selector.

2. The memory cartridge of claim 1 wherein the memory unit comprises a read only memory (ROM) chip.

3. The memory cartridge of claim 1 wherein the selector is a dial.

4. The memory cartridge of claim 1 wherein the locking member is positioned adjacent to the edge connector.

5. The memory cartridge of claim 1 wherein the housing comprises a recess and the edge connector is in the recess.

6. The memory cartridge of claim 1 wherein the selector is dial, and wherein the memory cartridge further comprises a structurally encoded wheel coupled to the dial.

7. The memory cartridge of claim 6 further comprising a plurality of movable fingers engaged by the structurally coded wheel, and a plurality of conductors being movable with the plurality of movable fingers.

8. The memory cartridge of claim 1 wherein the memory cartridge has a first side and a second side, and wherein the selector is a dial at a first side of the memory cartridge and wherein the memory cartridge comprises a window at the second side of the memory cartridge.

9. The memory cartridge of claim 8 wherein the memory cartridge further comprises a structurally encoded wheel coupled to the dial, and wherein the structural encoded wheel comprises a plurality of indicia, wherein at least one indicium of the plurality of indicia shows through the window.

10. The memory cartridge of claim 1 wherein the plurality of data sets comprise a plurality of data sets for audio for respectively different books.

11. The memory cartridge of claim 1 wherein the plurality of data sets comprise a plurality of data sets for audio for respectively different sheets.

12. A kit comprising:
(a) a memory cartridge comprising (i) a housing, (ii) a memory unit in the housing, wherein the memory unit stores a plurality of data sets for different print media, (iii) an edge connector electrically coupled to the memory unit, (iv) a selector coupled to the housing, wherein the selector is adapted to select at least one of the data sets, and (v) a locking member for locking the selector; and
(b) the different print media.

13. The kit of claim 11 wherein the memory unit comprises a read only memory (ROM), and the different print media comprise different books.

14. An electrographic position location apparatus comprising:
(a) the memory cartridge of claim 1;
(b) an electronic position location system coupled to the memory cartridge;
(c) a stylus; and
(d) a housing comprising a surface, wherein the electronic position location system is capable of determining a location of the stylus over the surface.

15. The electrographic position location apparatus of claim 14 wherein the electronic position location system includes a receiving antenna in the stylus and a transmitting antenna under the surface of the housing.

16. The electrographic position location apparatus of claim 14 wherein the housing is in the form of a globe.

17. The electrographic position location apparatus of claim 14 wherein the housing is in the form of a platform.

18. A memory cartridge comprising:
(a) a housing having a first side and a second side;
(b) a memory unit in the housing, wherein the memory unit stores a plurality of data sets for different print media;
(c) a selector coupled to the housing, wherein the selector is adapted to select at least one of the data sets; and
(d) an edge connector electrically coupled to the memory unit.

19. The memory cartridge of claim 18 further comprising:
(e) a dial at the second side of the housing, wherein the dial is adapted to select at least one of the data sets; and
(f) a wheel coupled to the dial, wherein the wheel has a structurally coded surface at a first side and a plurality of indicia at a second side.

20. The memory cartridge of claim 18 further comprising a locking member adjacent to the edge connector.

21. The memory cartridge of claim 20 wherein the locking member and the edge connector are disposed in a recess in the housing.

22. The memory cartridge of claim 18 wherein the memory unit is a single read only memory (ROM) chip.

23. The memory cartridge of claim 18 further comprising an illumination source inside of the housing.

24. The memory cartridge of claim 23 wherein the illuminating source is adjacent to a wheel in the housing, and wherein the wheel comprises a translucent or a transparent material.

25. A kit comprising:
(a) a memory cartridge comprising (i) a housing having a first side and a second side, (ii) a memory unit in the housing, wherein the memory unit stores a plurality of data sets for different print media, (iii) a selector coupled to the housing, wherein the selector is adapted to select at least one of the data sets, and (iv) an edge connector electrically coupled to the memory unit; and
(b) the different print media.

26. The kit of claim 25 wherein the different print media are different books or different printed sheets.

27. An electrographic position location apparatus comprising:
(a) the memory cartridge of claim 18;
(b) an electronic position location system coupled to the memory cartridge;
(c) a stylus; and
(d) a housing comprising a surface,
wherein the electronic position location system is capable of determining a location of the stylus over the surface.

28. The electrographic position location apparatus of claim 27 wherein the electronic position location system includes a receiving antenna in the stylus and a transmitting antenna under the surface of the housing.

29. The electrographic position location apparatus of claim 27 wherein the housing is in the form of a platform which houses an antenna.

30. The electrographic position location apparatus of claim 27 wherein the housing is in the form of a platform.

31. A memory cartridge comprising:
(a) a housing having a first side and a second side;
(b) a window at the first side of the housing;
(c) a memory unit in the housing, wherein the memory unit stores a plurality of data sets for different print media;
(d) an edge connector electrically coupled to the memory unit;
(e) a dial at the second side of the housing, wherein the dial is adapted to select at least one of the data sets;
(f) a wheel coupled to the dial, wherein the wheel has a structurally coded surface at a first side and a plurality of indicia at a second side, wherein at least one indicium of the plurality of indicia shows through the window;
(g) an illumination source between the wheel and the dial; and
(h) a locking member for locking the selector, the locking member being coupled to housing.

32. The memory cartridge of claim 31 wherein the different print media are different books.
